(19) United States
(12) Patent Application Publication
(10) Pub. No.: US 2007/0002495 A1
(43) Pub. Date: Jan. 4, 2007

(54) Magnetic disc apparatus

(75) Inventors: Hiroshi Nagata, Kawasaki (JP); Mitsuaki Yoshida, Kawasaki (JP); Hisashi Kaneko, Kawasaki (JP); Masaya Suwa, Kawasaki (JP); Yoshiaki Koizumi, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/282,722

(22) Filed: Nov. 21, 2005

(30) Foreign Application Priority Data
Jul. 4, 2005 (JP) 2005-195365

(51) Int. Cl. G11B 5/55

(52) U.S. Cl. 360/264.7

(57) ABSTRACT

A magnetic disc apparatus has a voice coil motor including a magnetic member constituting a magnetic circuit, a cover member covering the magnetic member, and a buffer member interposed between the magnetic member and the cover member. The magnetic member and the cover member are screwed with the buffer member interposed therebetween.

### BACKGROUND OF THE INVENTION

1. Field of the Invention

The present invention relates to a magnetic disc apparatus in which a magnetic head is positioned on a rotating magnetic disk to access the magnetic disk.

2. Description of the Related Art

Conventionally magnetic disk apparatus have been widely used as storage apparatus for a computer. With the increased recording density of magnetic disks to be employed in magnetic disk apparatus in recent years, there is a demand for higher-accurate positioning of the magnetic head so that it can access the magnetic disk precisely.

After a magnetic disc of magnetic disc apparatus is driven to start rotating so as to be accessed, temperature in the magnetic disc apparatus gradually rises. In the process of temperature rise, a joint section fastened by components with different materials undergoes difference in displacement because the components have different expansion factors. Moreover, due to its friction the joint section does not undergo smooth displacement, which is accompanied by vibration when the displacement and the friction is off-balance. The vibration travels to a magnetic head at the tip of a carriage arm and causes the magnetic head to be deviated from the normal position, possibly leading to access error.

Japanese Patent Laid-Open No. 64-73572 discloses the configuration in which the magnet member constituting the voice coil motor is fixed to the carriage block and plates for decreasing frictional force are inserted therebetween. However, there is no description on how to prevent occurrence of vibration.

### SUMMARY OF THE INVENTION

The present invention has been made in view of the above circumstances, and provides a magnetic disc apparatus so configured as to reduce access error in the magnetic disk by preventing occurrence of vibration.

The present invention provides a magnetic disc apparatus having:

a magnetic disc;

a spindle motor rotating the magnetic disc;

a carriage arm having a magnetic head for accessing the magnetic disc at the tip thereof; and

a voice coil motor driving the magnetic head at the tip of the carriage arm to swing on the magnetic disk in the direction of the radius of the magnetic disk, the magnetic head being positioned on the rotating magnetic disk to access the magnetic disk,

wherein the voice coil motor includes:

a magnetic member constituting a magnetic circuit,

a cover member covering the magnetic member, and

a buffer member interposed between the magnetic member and the cover member.

Preferably, the magnetic member and the cover member are screw-fixed each other with the buffer member interposed therebetween.

Further preferably, the buffer member is a resin member and the magnetic member is, for example, an iron member. The cover member may be a brass member or an aluminum alloy member.

As described above, according to the magnetic disc apparatus of the present invention, it is possible to reduce access error in the magnetic disc because of a buffer member provided between a magnetic member and a cover member, which makes displacement due to thermal expansion smooth and thus prevents vibration by sudden displacement.

### BRIEF DESCRIPTION OF THE DRAWINGS

FIG. 1 is a plane view of a magnetic disc apparatus with its upper cover removed according to one embodiment of the present invention.

FIG. 2 is a sectional view of the magnetic disc apparatus shown in FIG. 1.

FIG. 3 is an exploded perspective view of a magnetic member and a cover member constituting a voice coil motor.

### DETAILED DESCRIPTION OF THE INVENTION

An embodiment of the present invention will be described below with reference to the attached drawings.

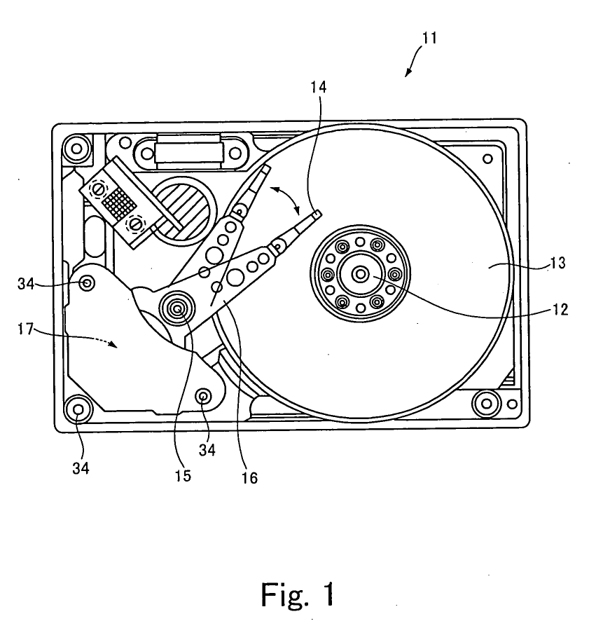

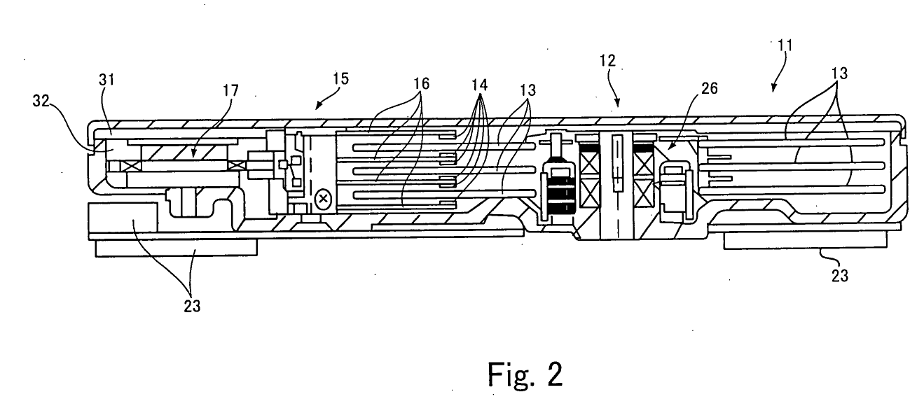

FIG. 1 is a plane view of a magnetic disc apparatus with its cover removed according to an embodiment of the present invention and FIG. 2 is a sectional view of the magnetic disc apparatus shown in FIG. 1.

The magnetic disc apparatus 11 is provided with a magnetic disc 13 which is driven to rotate around a rotating shaft 12 by a Disc Control Motor (DCM) 26 composed of a spindle motor (see FIG. 2). The magnetic disc apparatus 11 further includes a carriage arm 16 having a magnetic head 14 at the tip thereof as opposed to the magnetic disc 13 and swinging around a swing shaft 15, and a voice coil motor (VCM) 17 which drives the carriage arm 16 to swing and causes the magnetic head 14 to move in the direction of the radius of the magnetic disc 13. Writing data to and reading data stored in the magnetic disc 13 is performed as follows: The carriage arm 16 is driven to swing by the VCM 17 while the magnetic disc 13 is being rotated driven by the DCM 26, which causes the magnetic head 14 at the tip of the carriage arm 16 to be positioned at a desired track on the magnetic disc 13. Then, the magnetic head 14 magnetically and sequentially writes data to or picks up data from the desired track on the magnetic disc 13 accompanying the rotation of the magnetic disc 13.

FIG. 2 shows a magnetic member 32 made of iron which is a component constituting a magnetic circuit of the voice coil motor 17, a cover member 31 made of brass to cover the magnetic member 32, and a control circuit block 23 which controls operation of the magnetic disc apparatus 11.

Incidentally, the cover member 31 may be made of aluminum alloy.

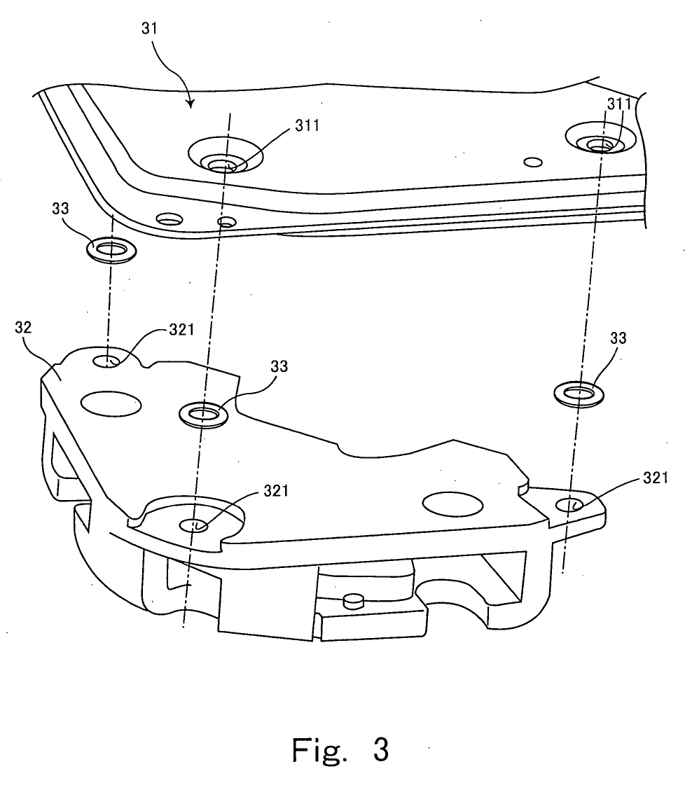

FIG. 3 is an exploded perspective view of the magnetic member 32 and the cover member 31 constituting the voice coil motor 17.

The magnetic member 32 is made of iron constituting a magnetic circuit of the voice coil motor 17 (see FIG. 2) and is provided with a tapped hole 321 having a female thread formed thereon to fix the cover member thereto.

On the other hand, the brass-made cover member 31 is heavy, contributing to vibration reduction of the voice coil motor 17. The cover member 31 has through holes 311, at the position corresponding to the tapped hole 321 of the magnetic member 32, through which a screw 34 (see FIG. 1) is inserted and secured. The screw 34 is first inserted into the through holes 311, passes through a center hole of a buffer member 33 so that the buffer member 33 is interposed between the cover member 31 and the magnetic member 32, and then is engaged with the tapped hole 321. The buffer member 33 is made of, for example, Teflon™ or resin material such as polyimide. When the magnetic disc apparatus 11 starts operating, the cover member 31 and the magnetic member 32 undergo displacement caused by thermal expansion. However, the buffer member 33 interposed between them makes displacement smooth and suppresses occurrence of vibration due to sudden change in displacement, which prevents access error caused by accidental vibration of the magnetic head 14 and enhances performance on the tracks.

What is claimed is:

1. A magnetic disc apparatus comprising:
a magnetic disc;
a spindle motor rotating the magnetic disc;
a carriage arm having a magnetic head for accessing the magnetic disc at the tip thereof; and
a voice coil motor driving the magnetic head at the tip of the carriage arm to swing on the magnetic disk in the direction of the radius of the magnetic disk, the magnetic head being positioned on the rotating magnetic disk to access the magnetic disk,
wherein the voice coil motor includes:
a magnetic member constituting a magnetic circuit,
a cover member covering the magnetic member, and
a buffer member interposed between the magnetic member and the cover member.

2. The magnetic disc apparatus according to claim 1, wherein the magnetic member and the cover member are screw-fixed to each other with the buffer member interposed therebetween.

3. The magnetic disc apparatus according to claim 1, wherein the buffer member is a resin member.

4. The magnetic disc apparatus according to claim 1, wherein the magnetic member is an iron member.

5. The magnetic disc apparatus according to claim 1, wherein the cover member is a brass member.

6. The magnetic disc apparatus according to claim 1, wherein the cover member is an aluminum alloy member.
